(19) United States
(12) Patent Application Publication
(10) Pub. No.: US 2009/0078759 A1
(43) Pub. Date: Mar. 26, 2009

(54) Electronic Device, Method and Computer-Readable Recording Medium for Controlling Electronic Device

(75) Inventors: Hideki Watanabe, Tokyo (JP); Mitsuharu Fukazawa, Tokyo (JP)

Correspondence Address: IPUSA, P.L.L.C, 1054 31ST STREET, N.W., Suite 400, Washington, DC, 20007, US

(73) Assignee: SEGA CORPORATION

(21) Appl. No.: 12/207,658

(22) Filed: Sep. 10, 2008

(30) Foreign Application Priority Data
Sep. 20, 2007 (JP) 2007-244316

(51) Int. Cl. G06K 5/00

(52) U.S. Cl. 235/380

(57) ABSTRACT

An electronic device having a maneuvering part provided at an external part of the electronic device for maneuvering the electronic device that includes a unique data storage part configured to store unique data identifying a valid non-contact key medium, a data reading part configured to read data stored in a target non-contact key medium placed in the vicinity of the data reading part, a validity determining part configured to determine whether the data read from the target non-contact key medium are valid by comparing the data read from the target non-contact key medium with the unique data, and a mode switching part configured to switch the maneuvering part from a regular mode to an adjustment mode for adjusting the electronic device in a case where the validity determining part determines that the data read from the target non-contact key medium are valid.

### BACKGROUND OF THE INVENTION

1. Field of the Invention

The present invention generally relates to an electronic device, a method and a computer-readable recording medium for control of the electronic device.

2. Description of the Related Art

Game machines installed at amusement facilities and the like are subject to various adjustments (e.g., adjustment of playing fees or adjustment of game level). For example, the fee for playing a game may be adjusted as 100 yen per game. In a case of adjusting the game level of a crane-type prize catching game machine, the game level may be adjusted by adjusting the strength of the arm of the crane.

FIG. 1 illustrates an external view of a game machine 10 according to a related art example. The game machine 10 has a service door 10a located at its lower part on the side facing the player (operator) of the game machine 10). In a case of performing adjustments on the game machine 10, a facility managing person opens the service door 10a and performs various operations on a service panel provided inside the game machine 10 (See, for example, Japanese Laid-Open Patent 2006-122510).

As illustrated with the game machine 10, since adjustment is to be performed by opening the service door 10a with a key and operating on the service panel, the facility managing person has to perform the adjustment by bending down and maintaining an uncomfortable position. Performing adjustments in this manner may decrease efficiency. Furthermore, since adjustments are often performed during working hours, an adjustment operation that lacks efficiency may increase the time for adjustment and cause customers to wait to play the game machine being adjusted. This leads to degradation of customer service. Furthermore, kneeling in front of the game machine is not pleasant for either the facility managing person or the customer watching the facility managing person kneeling in front of the game machine. These problems apply not only to game machines but also to other electronic machines that are subject to adjustment and used by an unspecified number of people.

### SUMMARY OF THE INVENTION

The present invention may provide an electronic device, an electronic device controlling method, and a computer-readable recording medium that substantially eliminate one or more of the problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by an electronic device, an electronic device controlling method, and a computer-readable recording medium particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides an electronic device having a maneuvering part provided at an external part of the electronic device for maneuvering the electronic device, including: a unique data storage part configured to store unique data identifying a valid non-contact key medium; a data reading part configured to read data stored in a target non-contact key medium placed in the vicinity of the data reading part; a validity determining part configured to determine whether the data read from the target non-contact key medium are valid by comparing the data read from the target non-contact key medium with the unique data; and a mode switching part configured to switch the maneuvering part from a regular mode to an adjustment mode for adjusting the electronic device in a case where the validity determining part determines that the data read from the target non-contact key medium are valid.

Furthermore, another embodiment of the present invention provides a method of controlling an electronic device having a maneuvering part provided at an external part of the electronic device for maneuvering the electronic device, a storage part, and a data reading part, the method comprising the steps of: a) storing unique data identifying a valid non-contact key medium in the storage part; b) reading data from a target non-contact key medium placed in the vicinity of the data reading part; c) determining whether the data read from the target non-contact key medium are valid by comparing the data read from the target non-contact key medium with the unique data; and d) switching the maneuvering part from a regular mode to an adjustment mode for adjusting the electronic device in a case where the data read from the target non-contact key medium are determined to be valid.

Furthermore, another embodiment of the present invention provides a computer-readable recording medium on which a program is recorded for causing a computer to execute a method of controlling an electronic device having a maneuvering part provided at an external part of the electronic device for maneuvering the electronic device, a storage part, and a data reading part, the method including the steps of: a) storing unique data identifying a valid non-contact key medium in the storage part; b) reading data from a target non-contact key medium placed in the vicinity of the data reading part; c) determining whether the data read from the target non-contact key medium are valid by comparing the data read from the target non-contact key medium with the unique data; and d) switching the maneuvering part from a regular mode to an adjustment mode for adjusting the electronic device in a case where the data read from the target non-contact key medium are determined to be valid.

Other objects and further features of the present invention will be apparent from the following detailed description when read in conjunction with the accompanying drawings.

### BRIEF DESCRIPTION OF THE DRAWINGS

FIG. 1 is a schematic external view of a game machine according to a related art example;

FIG. 2 is a schematic diagram illustrating a game machine and its peripheral components according to an embodiment of the present invention;

FIGS. 3A and 3B are schematic diagrams illustrating an exemplary data structure maintained in an IC (integrated circuit) card and a game machine according to an embodiment of the present invention, respectively;

FIG. 4 is a flowchart illustrating an exemplary ID (identification) registration process according to an embodiment of the present invention;

FIGS. 5A and 5B are flowcharts for describing an exemplary verification operation according to an embodiment of the present invention; and

FIG. 6 is a schematic diagram for describing adjustment by using a game controller part of a game machine according to an embodiment of the present invention.

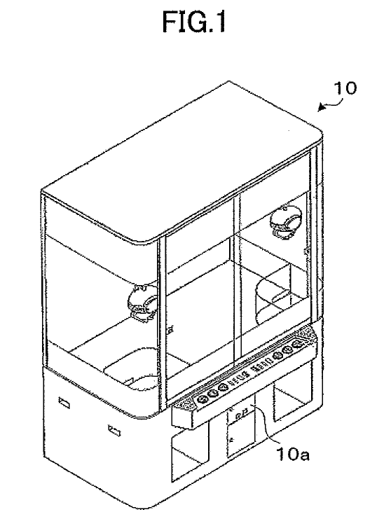

### DESCRIPTION OF THE PREFERRED EMBODIMENTS

In the following, embodiments of the present invention are described with reference to the accompanying drawings.

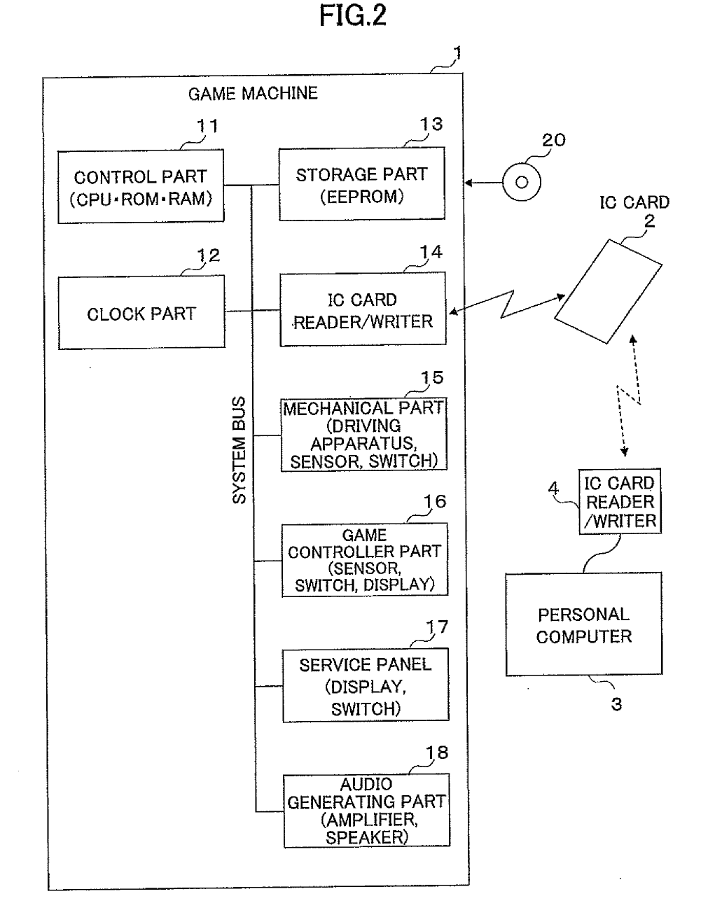

FIG. 2 is a schematic diagram illustrating an electronic device (in this embodiment, a game machine) 1 and its peripheral components according to an embodiment of the present invention.

With reference to FIG. 2, an IC card 2, acting as a non-contact key medium, is carried by a facility managing person (not illustrated). When the game machine 1 detects the IC card 2 in its vicinity, the game machine 1 determines whether the IC card 2 has a valid key. In a case where the IC card 2 is valid, the game machine 1 can shift from a game mode (regular mode) to an adjustment mode according to the settings (data) inside the IC card 2. The game mode is for providing a main function of enabling a user (e.g., player) to play a game by operating a game controlling part (maneuvering part) 16 of the game machine 1. For example, in a case where the game machine 1 is a prize obtaining game machine, the main function is to enable a user to play a prize obtaining game with the game machine 1. In a case where the game machine 1 is a video game machine, the main function is to enable a user to play a video game with the game machine 1. On the other hand, the adjustment mode is for providing a function enabling a user (e.g., facility managing person) to perform various adjustments on the game machine 1. In a case where the game machine 1 is in the adjustment mode, the facility managing person can perform various adjustments by using the game controlling part 16 such as buttons that are normally used for playing a game. Furthermore, the game machine 2 also has a function of writing (registering), for example, management data stored inside the game machine 1 to the IC card 2 according to the settings in the IC card 2. The management data are among the data indicating the operational status of the game machine 1. The management data includes data indicating, for example, 100 yen income (number of 100 yen coins deposited), 500 yen income (number of 500 coins deposited), payout number (number of prizes paid out), number of games played, and number of free credits (number of games played free of charge). Other data indicating the operational status of the game machine 1 besides the management data may also be written in the IC card 2.

The game machine 1 includes, for example, a control part 11, a clock part 12, a storage part 13, an IC reader/writer 14, a mechanical part 15, the game controlling part 16, a service panel 17, and an audio generating part 18 that are connected to a system bus.

The control part 11 includes, for example, a central processor (CPU (Central Processing Unit)), a ROM (Read Only Memory), and a RAM (Random Access Memory). The control part 11 controls the entire game machine 1 according to a program stored in the ROM or the RAM. The program may be recorded in a computer-readable recording medium 20 that is installed into the game machine 1 for enabling the control part 11 to control the entire game machine 1.

The clock part 12 outputs data indicating date and time (time/date data). The time/date data are used when recording data onto a log.

The storage part 13 includes, for example, a memory such as a non-volatile EEPROM (Electrically Erasable Programmable Read Only Memory). The storage part 13 stores, for example, data of a valid IC card (e.g., card ID, authority flag), management data, and log data.

The IC card reader/writer 14 writes data to or reads data from, for example, an RFID (Radio Frequency Identification) tag inside the IC card 2 when the IC card 2 is in the vicinity of the IC card reader/writer 14.

The mechanical part 15 includes components such as a driving apparatus, a sensor, and/or a switch. The components of the mechanical part 15 differ depending on the type of the game machine 1.

The game controlling part (maneuvering part) 16 includes components such as a sensor, a switch, and/or a display. The components of the game controlling part 16 differ depending on the type of the game machine 1. The game controlling part 16 is used for enabling a user (player) to control (maneuver) a game when the game machine 1 is in the game mode (regular mode) and used for enabling the facility managing person to perform various adjustments (adjustment mode). The game controlling part 16 is provided at an external part of the game machine 1 that enables easy control (maneuvering) for the player.

The service panel 17 includes components such as a display and/or a switch. The service panel 17 is used for ID registration and also for performing various adjustments by the facility managing person. The service panel 17 is typically provided at a part of the game machine 1 that cannot be seen by the player. For example, the service panel 17 may be located below the game controlling part 16 inside a service door locked by a key.

The audio generating part 18 includes, for example, an amplifier and/or a speaker. The audio generating part 18 reproduces BGM (Background Music) and sound effects according to the type of the game machine 1.

The IC card 2 is configured to have data read from and data written to it by an IC card reader/writer 4 connected to a personal computer 3. The personal computer 3 is used for, for example, formatting the IC card 2, writing (registering) card ID data (batch registration card ID data) in a batch, or collecting management data from the game machine 1 via the IC card 2. Furthermore, authorization flags (described in detail below) may be set generally or specifically in the IC card(s) 2 formatted or having card ID data written by the game apparatus 1 in order to prevent the IC card(s) 2 from being used for collecting management data. For example, in some cases, it may be suitable for only a specific person among the facility managing personnel (e.g., facility manager) to collect management data. Therefore, for example, an authorization changing process using particular software in the personal computer 3 may be required in order for management data to be collected with the IC card 2.

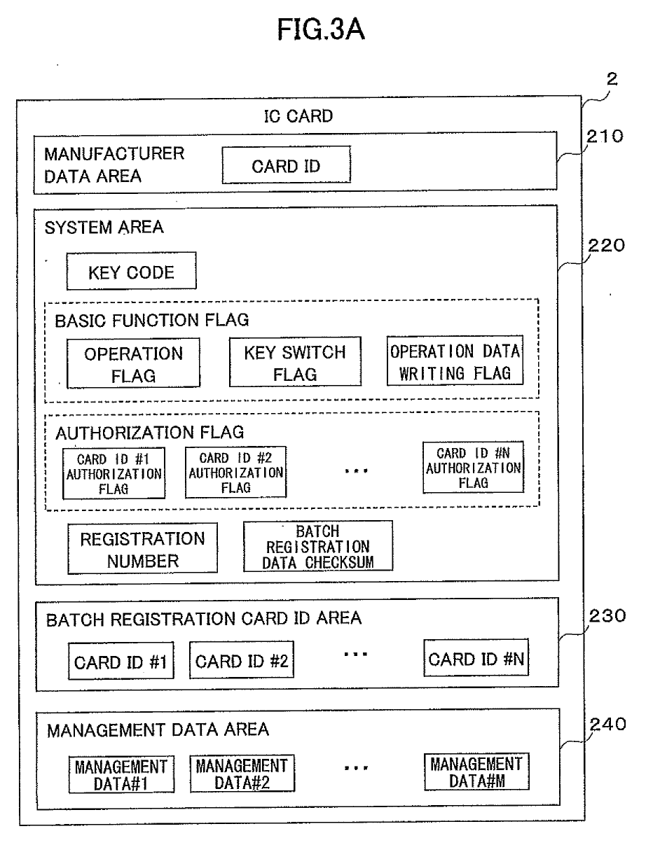

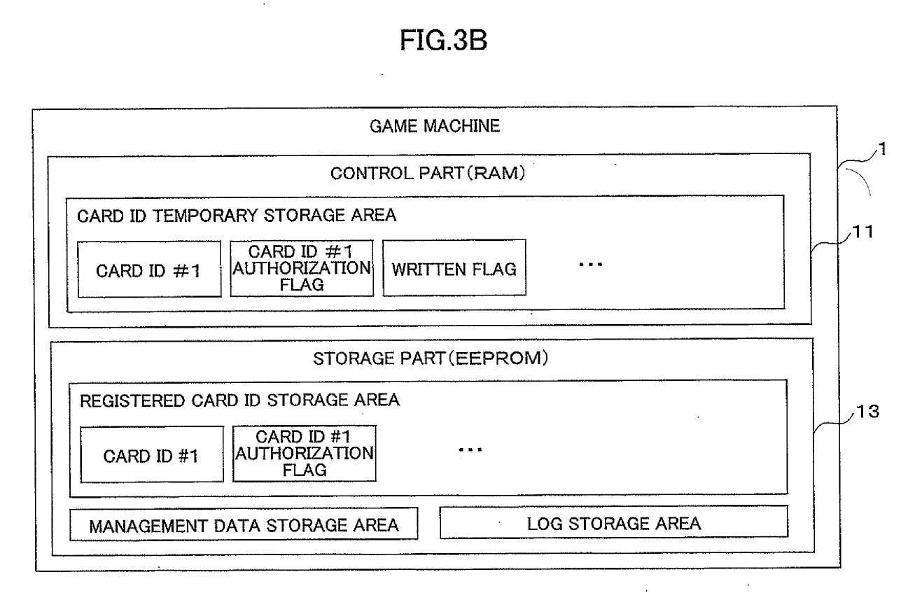

FIGS. 3A and 3B are schematic diagrams illustrating an exemplary data structure maintained in the IC card 2 and the game machine 1 according to an embodiment of the present invention, respectively.

FIG. 3A illustrates the exemplary data structure of the IC card 2 having a manufacturer data area 210, a system area 220, a batch registration card ID area 230, and a management data area 240.

The manufacturer data area 210 is an area in which data are restricted from being rewritten. The manufacturer data area 210 includes unique card ID data for distinguishing (identifying) the IC card 2. The manufacturer data area 210 may also include, for example, serial numbers and data indicating the manufacturer of the ID card 2.

The system area 220 is an area in which management data of the IC card 2 are recorded. The system area 220 includes, for example, key code data, basic function flag data, authorization flag data, data indicating the number of card IDs registered, and batch registration checksum data. The key code data are data that are common for all IC cards 2 issued and managed by a system provider. The basic function flag data indicate functions that can be provided by the IC card 2. The basic function flag data include, for example, operational flag data indicating whether a function can be activated by the IC card 2, key switch flag data indicating whether adjustment can be conducted with the IC card 2, and management data writing flag indicating whether management data can be extracted with the IC card 2. The authorization flag data include generally set authorization data (general authorization data) for generally preventing execution of specific functions (e.g., extracting of management data) and specifically set authorization data (specific authorization data) for specifically allowing execution of the specific functions. The batch registration checksum data are generated, for example, by performing a hashing process on all card IDs.

The batch registration card ID area 230 is an area in which card ID data of all valid IC cards 2 are maintained for enabling card IDs to be registered to/from the game machine 1 in a batch. The maximum number of card IDs that can be registered (card ID maximum registration number) is “N” (for example, 20). Thus, the batch registration card ID area 230 has an area allowing N card IDs to be written (registered) thereto in a batch by the control part 11 of the game machine 1 or the personal computer 3.

The management data area 240 is an area in which management data extracted from the game machine 1 are maintained. The maximum number of management data items that can be registered (management data maximum registration number) is “M” (for example, 64). Accordingly, the management data area 240 has an area enabling M management data items to be written thereto.

FIG. 3B illustrates the exemplary data structure of the game machine 1 having data maintained in the RAM of the control part 11 and the EEPROM of the storage part 13.

The RAM of the control part 11 includes a card ID temporary storage area for storing a card ID and an authorization flag read out from the IC card 2 when registering the card ID in the game machine 1 and a corresponding flag(s) already written to the RAM up to a maximum registration number N.

The EEPROM of the storage part 13 includes a registered card ID storage area capable of storing a pair of a card ID and an authorization flag up to a maximum registration number N, a management data storage area for storing the management data, and a log storage area for storing a log of ID registrations.

### <Operation>

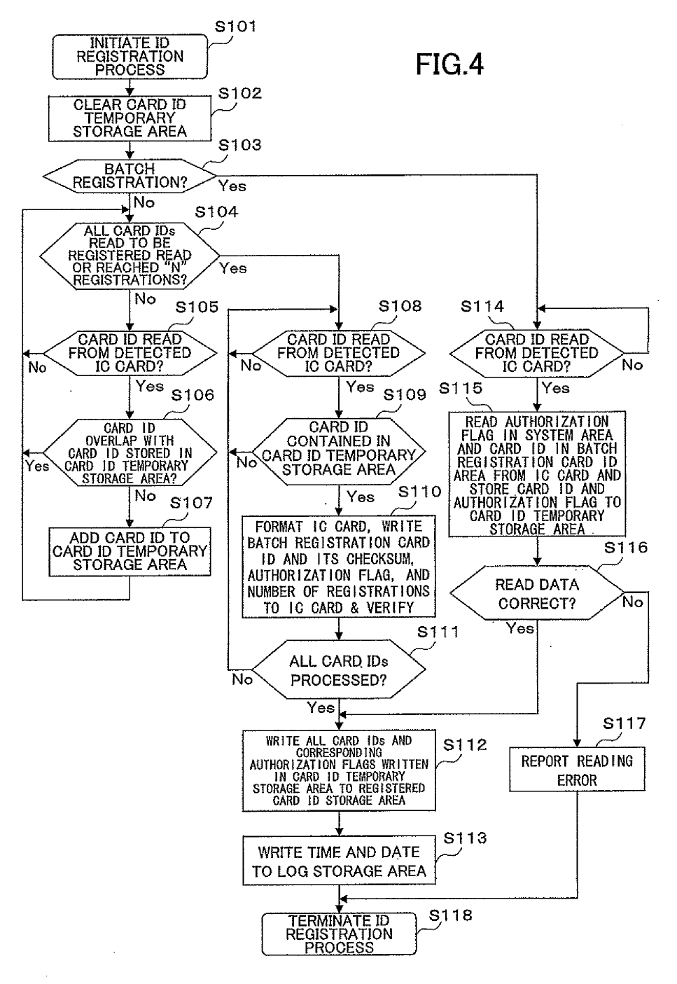

FIG. 4 is a flowchart illustrating an exemplary ID registration process of the game machine 1 according to an embodiment of the present invention. The ID registration process is performed operating the service panel 17 (illustrated in FIG. 2) after opening a locked service door of the game machine 1 with a key. This prevents an unauthorized person (a person having an IC card that can be used for the game machine 1 but not having the key for opening the service door of the game machine 1) from performing an ID registration process. Thereby, security can be maintained.

With an embodiment of the present invention, a card ID(s) can be registered in a game machine 1 in a situation of adding a new card ID to the game machine 1 (the game machine 1 to which the card ID is to be registered may be a new game machine or an existing game machine) by preparing all valid IC cards 2 or in a situation of registering a card ID to a new game machine by using one of existing IC cards 2 containing batch registration card ID data.

The former case corresponds to Steps S104-S113 in the flowchart illustrated in FIG. 4, and the latter case corresponds to Steps S114-S117, S112, and S113.

In FIG. 4, when an ID registration process is initiated by performing a predetermined operation on the service panel 17 of the game machine 1 (Step S101), the control part 11 clears the card ID temporary storage area of the RAM (Step S102).

Then, the control part 11 determines whether to register card ID data in a batch according to an item selected in the service panel 17 (Step S103).

In a case of not registering card ID data in a batch (No in Step S103), it is determined whether all of the card Is to be registered have been read or whether the number of card IDs have reached the card ID maximum registration number “N” (Step S104). Whether all card IDs have been read can be determined according to, for example, a “reading completed” operation (maneuver) performed on the service panel 17.

In a case where all of the card IDs to be registered have not been read or the number of card IDs to be registered have not reached the card ID maximum number (No in Step S104), the control part 11 detects an IC card 2 with the IC card reader/writer 14 and determines whether the detected IC card 2 has been read (Step S105). In a case where the detected IC card 2 has not yet been read (No in Step S105), the operation returns to Step S104 for determining whether all of the card IDs to be registered have been read or whether the number of card IDs have reached the card ID maximum registration number “N”.

In a case where the card ID has been read (Yes in Step S105), the control part 11 determines whether the card ID overlaps with (is contained in) the card IDs stored in the card ID temporary storage area of the RAM (Step S106). In a case where the card ID overlaps (Yes in Step S106), the operation returns to Step S104 for determining whether all of the card IDs to be registered have been read or whether the number of card IDs have reached the card ID maximum registration number “N”.

In a case where the card ID does not overlap (No in Step S106), the control part 11 adds (registers) the read card ID to the card ID temporary storage area of the RAM (Step S107) and returns to Step S104 for determining whether all of the card IDs to be registered have been read or whether the number of card IDs have reached the card ID maximum registration number “N”.

In a case where all of the card IDs to be registered have been read or the number of card IDs to be registered have reached the card ID maximum registration number “N” (Yes in Step S104), the control part 11 detects another IC card 2 with the IC card reader/writer 14 and determines whether the detected IC card 2 has been read (Step S108). The control part 11 waits (stands by) until the detected IC card 2 has been read.

In a case where the card ID is read (Yes in Step S108), the control part 11 determines whether the card ID overlaps with the card IDs stored in the card ID temporary storage area of the RAM (Step S109). In a case where the read card ID is not a card ID stored in the card ID temporary storage area (No in Step S109), the operation returns to Step S108 for determining whether the card ID has been read.

In a case where the read card ID is a card ID stored in the card ID temporary storage area (Yes in Step S109), the control part 11 performs processes including formatting the IC card 2, writing (registering) batch registration card ID data and their check sum, a predetermined authorization flag (operation flag ON, key switch flag ON, management data writing flag OFF) and the number of registrations to the IC card 2 according to data stored in the card ID temporary storage area (Yes in Step S109), and verifies (verification of the written data) (Step S110). Then, the control part 11 switches on a writing flag in the card ID temporary storage area which corresponds to the processed IC card 2.

Then, the control part 11 determines whether performing the processes of Steps S109 and S110 on all card IDs has been completed (Step S111). This determination is performed by determining whether there are any switched-off writing flags in the card ID temporary storage area of the RAM. In a case where performing Steps S109 and S110 on all card IDs is not completed (No in Step S111), the operation returns to Step S108 for determining whether another card ID has been read.

In a case where Steps S109 and S110 are performed on all card IDs (Yes in Step S111), the control part 11 writes (records) all of the card IDs and corresponding authorization flags written in the card ID temporary storage area of the RAM to the registered card ID storage area of the EEPROM (Step S112). Then, the control part 11 obtains the time and date in which the writing (registering) to the registered card ID storage area has been completed from the clock part 12 and writes (records) the obtained data to the log storage area of the EEPROM (Step S113). Then, the control part 11 terminates the ID registration operation (Step S118).

In a case of performing batch registration (Yes in Step S103), the control part 11 detects an IC card 2 with the IC card reader/writer 14 and determines whether the card ID has been read (Step S114), and then waits (stands by) until the detected IC card 2 has been read.

In a case where the card ID is read (Yes in Step S114), the control part 11 reads authorization flag in the system area and card ID data in a batch registration card ID area of the IC card 2 and stores the card ID and its authorization flag in the card ID temporary storage area of the RAM (Step S115).

Then, the control part determines whether the data read from the IC card is correct by determining whether a key code included in the system area is a predetermined value and whether all card IDs match according to batch registration data checksums (Step S116).

In a case where the read data are correct (Yes in Step S116), the control part 11 writes (records) all of the card IDs and corresponding authorization flags written in the card ID temporary storage area of the RAM to the registered card ID storage area of the EEPROM (Step S112). Then, the control part 11 obtains the time and date on which the writing (registering) to the registered card ID storage area has been completed from the clock part 12 and writes (records) the obtained data to the log storage area of the EEPROM (Step S113). Then, the control part 11 terminates the ID registration operation (Step S118).

In a case where the read data are incorrect (No in Step S116), the control part 11 reports a reading error (Step S117), for example, via a display of the game controller part 16. Thereby, the ID registration operation is completed (Step S118). For example, the read error may occur in a case where the IC card does not correspond to the system of the game machine 1 or a case where data of the IC card 2 are damaged.

Although FIG. 4 illustrates processes conducted by the game machine 1, the processes of Steps S102, S104-S111 may be conducted by the personal computer 3. Thus, the personal computer 3 can register the newest batch registration card ID to the IC card 2 via the IC card reader/writer 4.

As described above, a card ID(s) is registered in a game machine 1 in a situation of adding a new card ID to the game machine 1 (the game machine 1 to which the card ID is registered may be a new game machine or an existing game machine) by preparing all valid IC cards 2 or in a situation of registering a card ID to a new game machine by using one of existing IC cards 2 containing batch registration card ID data. In such situations, ID registration can be smoothly conducted even in a case where there is a change in the facility managing person responsible for holding the IC card 2 or a change of game machines to be managed. Furthermore, since the IC card 2 and the game machine 1 have the above-described data structure, irregularity of data can be easily detected by the below-described verification operation.

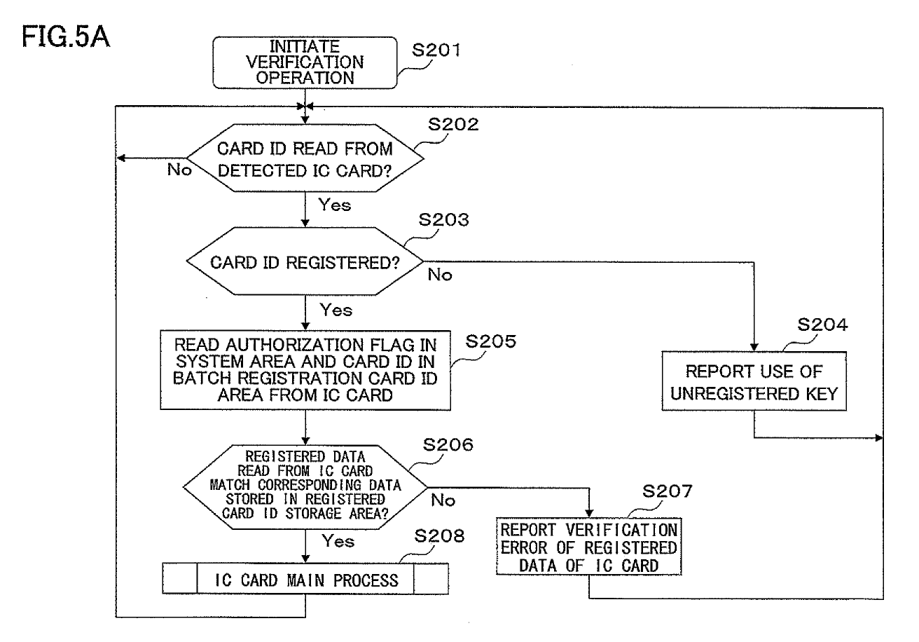

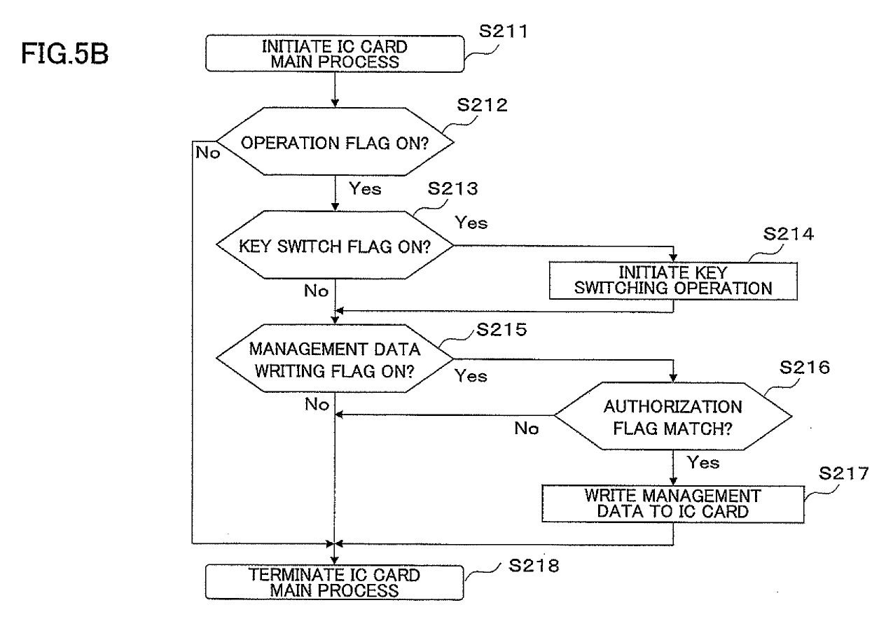

FIGS. 5A and 5B are flowcharts for describing an exemplary verification operation by the game machine 1 in a case where the IC card 2 is used according to an embodiment of the present invention.

In FIG. 5A, a verification operation is initiated when the game machine 1 is activated (Step S201). The verification operation is terminated when the game machine 1 is deactivated.

When the verification operation is initiated (Step S201), the control part 11 detects an IC card 2 with the IC card reader/writer 14 and determines whether a card ID is read from the IC card 2 (Step S202). The control part 11 waits (stands by) until the detected IC card 2 has been read.

In a case where the card ID is read (Yes in Step S202), the control part 11 determines whether the read card ID is a card ID registered in the registered card ID storage area of the EEPROM (Step S203). In a case where the read card ID is not registered (No in Step S203), the control part 11 reports use of an unregistered key via a display of the game controller part 16 (Step S204) and returns to Step S202 for waiting (standing by) for another card ID to be read from the IC card 2.

In a case where the read card ID is registered (Yes in Step S203), the control part 11 reads, for example, registered authorization flag data in the system area and registered card ID in a batch registration card ID area from the IC card 2 (Step S205) and determines whether the registered data read from the IC card 2 including data indicative of number of registrations match corresponding data (e.g., card ID, authorization flag) stored in the registered card ID storage area of the EEPROM (verification process, Step S206).

In a case where the data do not match (No in Step S206), the control part 11 reports a verification error of registered data of the IC card 2, for example, via a display of the game controller part 16 (Step S207) and returns to Step S202 for waiting (standing by) for another card ID to be read from the IC card 2.

For example, the verification error occurs 1) when another facility managing person uses a proper IC card 2 in a case where ID registration is performed on a game machine 1 without authorization, or 2) when an IC card 2 having tampered data is used. However, with the above-described embodiment of the present invention, even in a case where ID registration is performed by a person without authorization, the verification error in the situation of 1) can be detected, and the person using the IC card 2 with tampered data can be warned that the IC card 2 cannot be used in the situation of 2).

In a case where the data match (Yes in Step S206), the control part 11 conducts a below-described IC card main process (Step S208). Then, the operation returns to Step S202 for waiting (standing by) for another card ID to be read from the IC card 2.

FIG. 5B is a flowchart for describing the IC card main process of Step S208 of FIG. 5A in further detail.

With reference to FIG. 5B, when an IC card main process (Step S208) is initiated (Step S211), the control part 11 determines whether an operations flag in the basic function flags of the system area read from the IC card 2 is switched on (Step S212). In a case where the operations flag is not switched on (i.e. switched off) (No in Step S212), the control part 11 terminates the IC card main process (Step S218).

In a case where the operations flag is switched on (Yes in Step S212), the control part 11 determines whether a key switch flag is on (Step S213). In a case where the key switch flag is off (No in Step S213), the IC card main process proceeds to Step S215.

In a case where the key switch flag is on (Yes in Step S213), the control part 11 switches the game machine 1 from the game mode (regular mode) to the adjustment mode for initiating a key switching operation (Step S214). The key switching operation provides a state in which various adjustments can be performed by using the game controller part 16 (normally used for playing a game) instead of using the service panel 17. Accordingly, the same adjustments performed by using the service panel 17 can be achieved by using the game controller part 16. Furthermore, the key switching operation is continued by the control part 11 until the IC card 2 used for initiating the key switching operation cannot be detected. Accordingly, when the IC card 2 used for initiating the key switching operation is no longer detected, the key switching operation is terminated and the game machine 1 returns to the game mode. Alternatively, the game machine 1 may be returned to the game mode by allowing the user to terminate the adjustment mode (adjustment terminating operation) by pressing a button, for example.

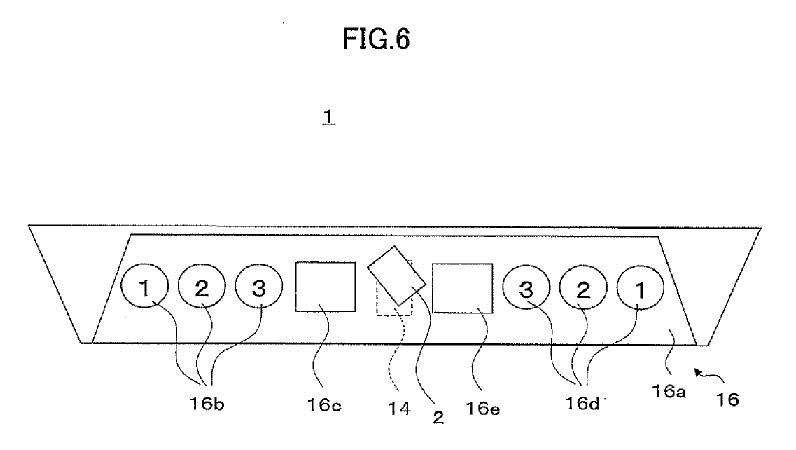

FIG. 6 is a schematic diagram for describing adjustment by using the game controller part 16 of the game machine 1. The game machine 1 changes to adjustment mode when a valid IC card 2 is detected in the vicinity of the IC card reader/writer 14 provided inside a control panel 16a of the game controller part 16. Selection of adjustment items and adjustment of the settings of the adjustment items can be conducted by suitably pushing buttons (buttons corresponding to player one) 16b of the game controller part 16. In this case, the adjustment items and the settings of the adjustment items are displayed in a display part (display corresponding to player one) 16c of the game controller part 16. Although this embodiment of the present invention describes a case of performing adjustment by using the buttons 16b and the display part 16c corresponding to player one, adjustment may be performed by using buttons 16d and a display part 16e corresponding to player two.

Returning to the flowchart of FIG. 5B, the control part 11 determines whether the management data writing flag is switched on (Step S215). In a case where the management data writing flag is switched on (Yes in Step S215), the control part 11 determines whether the authorization flag data read from the IC card 2 match with corresponding authorization flag data stored in the game machine 1 (Step S216).

In a case where the authorization flag data match (Yes in Step S216), the control part 11 writes management data to the IC card 2 (Step S217) and terminates the IC card main process (Step S218).

In a case where the authorization flag data do not match (No in Step S216), the control part 11 terminates the IC card main process (Step S218).

Further, the present invention is not limited to these embodiments, but various variations and modifications may be made without departing from the scope of the present invention.

The present application is based on Japanese Priority Application No. 2007-244316 filed on Sep. 20, 2007, with the Japanese Patent office, the entire contents of which are hereby incorporated herein by reference.

What is claimed is:

1. An electronic device having a maneuvering part provided at an external part of the electronic device for maneuvering the electronic device, comprising:
a unique data storage part configured to store unique data identifying a valid non-contact key medium;
a data reading part configured to read data stored in a target non-contact key medium placed in the vicinity of the data reading part;
a validity determining part configured to determine whether the data read from the target non-contact key medium are valid by comparing the data read from the target non-contact key medium with the unique data; and
a mode switching part configured to switch the maneuvering part from a regular mode to an adjustment mode for adjusting the electronic device in a case where the validity determining part determines that the data read from the target non-contact key medium are valid.

2. The electronic device as claimed in claim 1, further comprising:
a data writing part configured to write operational status data of the electronic device to the non-contact key medium in a case where the validity determining part determines that the data read from the target non-contact key medium are valid.

3. The electronic device as claimed in claim 1, wherein the maneuvering part includes a display for displaying a warning sent from the validity determining part;
wherein the validity determining part is configured to send the warning in a case where the validity determining part determines that the data read from the target non-contact key medium are invalid.

4. The electronic device as claimed in claim 1, wherein the unique data storage part is configured to store authorization flag data indicative of an authorized function of the valid non-contact key medium in correspondence with the unique data of the valid non-contact key medium; wherein the validity determining part is configured to determine whether the data read from the target non-contact key medium are valid by comparing the unique data and the authorization flag data stored in the unique data storage part with corresponding data read from the target non-contact key medium.

5. The electronic device as claimed in claim 1, further comprising:
a unique data registering part configured to register unique data included in the data read by the data reading part to the unique data storage part.

6. The electronic device as claimed in claim 1, further comprising:
a batch registration data writing part;
wherein the data reading part is configured to write the unique data stored in the unique data storage part to the target non-contact key medium in a batch.

7. A method of controlling an electronic device having a maneuvering part provided at an external part of the electronic device for maneuvering the electronic device, a storage part, and a data reading part, the method comprising the steps of:
a) storing unique data identifying a valid non-contact key medium in the storage part;
b) reading data from a target non-contact key medium placed in the vicinity of the data reading part;
c) determining whether the data read from the target non-contact key medium are valid by comparing the data read from the target non-contact key medium with the unique data; and
d) switching the maneuvering part from a regular mode to an adjustment mode for adjusting the electronic device in a case where the data read from the target non-contact key medium are determined to be valid.

8. A computer-readable recording medium on which a program is recorded for causing a computer to execute a method of controlling an electronic device having a maneuvering part provided at an external part of the electronic device for maneuvering the electronic device, a storage part, and a data reading part, the method comprising the steps of:
a) storing unique data identifying a valid non-contact key medium in the storage part;
b) reading data from a target non-contact key medium placed in the vicinity of the data reading part;
c) determining whether the data read from the target non-contact key medium are valid by comparing the data read from the target non-contact key medium with the unique data; and
d) switching the maneuvering part from a regular mode to an adjustment mode for adjusting the electronic device in a case where the data read from the target non-contact key medium are determined to be valid.
